(19) United States
(12) Patent Application Publication
(10) Pub. No.: US 2016/0198266 A1
(43) Pub. Date: Jul. 7, 2016

(54) EARPHONE AND MANUFACTURING METHOD FOR EARPHONE

(71) Applicant: TOSHIBA SAMSUNG STORAGE TECHNOLOGY KOREA CORPORATION, Suwon-si (KR)

(72) Inventors: Soohyun BAEK, Suwon-si (KR); Minsoo KANG, Seoul (KR); Seunghak LEE, Seongnam-si (KR); Youngbin LEE, Suwon-si (KR)

(73) Assignee: TOSHIBA SAMSUNG STORAGE TECHNOLOGY KOREA CORPORATION, Suwon-si (KR)

(21) Appl. No.: 14/985,558

(22) Filed: Dec. 31, 2015

(30) Foreign Application Priority Data
Dec. 31, 2014 (KR) 10-2014-0195773

(51) Int. Cl. H04R 11/02; H04R 7/16; H04R 31/00; H04R 1/10

(52) U.S. Cl. CPC H04R 11/02; H04R 1/1058; H04R 7/16; H04R 31/006

(57) ABSTRACT

An earphone and a manufacturing method of the earphone are disclosed. The earphone includes a diaphragm configured to vertically move in response to a vibration occurring based on a movement of an armature and delivered through a rod.

### TECHNICAL FIELD

Example embodiments relate to an earphone and a manufacturing method of the earphone.

### BACKGROUND ART

An audio device may include a speaker configured to generate a sound. The speaker may include driver units classified as a dynamic type and an armature type. The armature type of driver unit may operate as described below.

When a current is applied to a coil, an armature disposed between permanent magnets may be changed to an N-pole and an S-pole based on a principle of electromagnets and may vibrate in a vertical direction. In response to a vibration of the armature, a metal diaphragm connecting the armature and a thin driver rod may vibrate such that a sound is reproduced. In terms of structure, the armature type of driver unit may provide higher sensitivity, sound insulation, resolution, and a smaller size when compared to the dynamic type of driver unit.

However, the driver rod connecting the armature and the diaphragm may need to be provided in a small size to vertically connect the armature and the diaphragm and thus, manufacturing of the driver rod may be technically difficult.

### DISCLOSURE OF INVENTION

### Technical Goals

Example embodiments provide a balanced armature with reduced amount of manufacturing time and manufacturing costs by integrally forming a diaphragm with a rod configured to deliver a vibration of an armature to the diaphragm and producing the diaphragm including the rod through a one-time press work.

Example embodiments also provide a balanced armature with reduced amount of manufacturing time and manufacturing costs by integrally forming a rod configured to deliver a vibration of an armature to a diaphragm with a guide configured to fix the diaphragm and producing the diaphragm including the rod and the guide through a one-time press work.

Example embodiments also provide a balanced armature by arranging at least one hole or at least one connector in an area in which a diaphragm is connected with a fixture or a guide configured to fix the diaphragm so as to achieve a desired modulus of elasticity of the diaphragm moving in response to a vibration of an armature.

### Technical Solutions

According to example embodiments, there is provided an earphone including an armature configured to vertically move between permanent magnets based on a magnetic polarity of a coil, and a diaphragm configured to vertically move in response to a vibration occurring based on a movement of the armature, wherein the diaphragm is integrally formed with a rod configured to deliver the vibration occurring based on the movement of the armature.

The rod may be disposed perpendicular to a partial area of the diaphragm.

The one end of the rod may be connected to one end of the armature.

At least one hole or at least one protrusion having a predetermined length may be formed at one end of the rod.

According to other example embodiments, there is also provided an earphone including an armature configured to vertically move between permanent magnets based on a magnetic polarity of a coil, and a diaphragm configured to vertically move in response to a vibration occurring based on a movement of the armature, wherein the diaphragm is integrally formed with a fixture configured to fix the diaphragm or a rod configured to deliver the vibration occurring based on the movement of the armature.

An area in which the diaphragm and the fixture are connected to each other may be present, and a connector for a modulus of elasticity of the diaphragm may be disposed in the area

A length of the connector, a thickness of the connector, or a number of connectors may be determined based on the modulus of elasticity of the diaphragm.

An area in which the diaphragm and the fixture are connected to each other may be present, and a hole for a modulus of elasticity of the diaphragm may be formed in the area.

A size of the hole or a number of holes may be determined based on the modulus of elasticity of the diaphragm.

The rod may be disposed perpendicular to a partial area of the diaphragm.

One end of the rod may be connected to one end of the armature.

At least one hole or at least one protrusion having a predetermined length may be formed at one end of the rod.

According to other example embodiments, there is also provided an earphone including an armature configured to vertically move between permanent magnets based on a magnetic polarity of a coil, and a diaphragm configured to vertically move in response to a vibration occurring based on a movement of the armature, wherein the diaphragm is integrally formed with a guide used in housing of the earphone or a rod configured to deliver the vibration occurring based on the movement of the armature.

The guide may include an area forming a double step difference with an upper face of the guide so as to arrange the diaphragm below the upper face by a predetermined depth.

The rod may be disposed perpendicular to a partial area of the diaphragm.

One end of the rod may be connected to one end of the armature.

At least one hole or at least one protrusion having a predetermined length may be formed at one end of the rod.

The armature may be divided into an upper portion and a lower portion having a symmetric relationship or an asymmetric relationship, or the armature may be undivided into the upper portion and the lower portion.

When the armature is divided into the upper portion and the lower portion, the armature may be provided in a U shape or a 90-degree rotated U shape.

### Effects

According to example embodiments, it is possible to reduce an amount of manufacturing time and manufacturing costs by integrally forming a diaphragm with a rod configured to deliver a vibration of an armature to the diaphragm and producing the diaphragm including the rod through a one-time press work.

According to example embodiments, it is possible to reduce an amount of manufacturing time and manufacturing costs by integrally forming a rod configured to deliver a vibration of an armature to a diaphragm with a guide configured to fix the diaphragm and producing the diaphragm including the rod and the guide through a one-time press work.

According to example embodiments, it is possible to arrange at least one hole or at least one connector in an area in which a diaphragm is connected with a fixture or a guide configured to fix the diaphragm, thereby achieving a desired modulus of elasticity of the diaphragm moving in response to a vibration of an armature.

### BRIEF DESCRIPTION OF DRAWINGS

FIG. 1 is a diagram illustrating a portion of elements in a balanced armature included in an earphone according to an example embodiment.

FIG. 2 is a diagram illustrating a balanced armature according to an example embodiment.

### BEST MODE FOR CARRYING OUT THE INVENTION

Hereinafter, example embodiments will be described in detail with reference to the accompanying drawings.

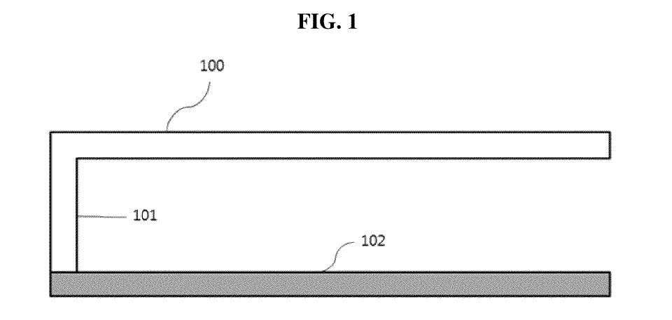

FIG. 1 is a diagram illustrating a portion of elements of a balanced armature included in an earphone according to an example embodiment.

Referring to FIG. 1, a portion of elements included in a balanced armature is provided. A diaphragm 100 includes a rod 101 connected to an armature 102. In general, the diaphragm 100 and the rod 101 may be provided separately in the balanced armature. In an example embodiment, the diaphragm 100 may include the rod 101 as an element. The diaphragm 100 may be formed with a metal material. The rod 101 may be disposed perpendicular to a partial area of the diaphragm 100.

To reproduce a sound using the balanced armature, a current corresponding to the sound may flow through a voice coil included in the balanced armature. A magnetic field created by the current may trigger the armature 102 to have a magnetic polarity (like N-pole or S-pole). The armature 102 may move based on a polarity of a permanent magnet included in the balanced armature and thus, a vibration may occur. Subsequently, the vibration occurring in the armature 102 may be delivered to the diaphragm 100 through the rod 101 connected with the armature 102. Thus, the sound may be reproduced based on a vibration occurring in response to the diaphragm 100 vertically moving based on the vibration occurring in the armature 102.

Referring to FIG. 1, the armature 102 may be provided in a U shape and an upper portion and a lower portion of the armature 102 may be asymmetrical to each other. However, the foregoing is provided as an example. Thus, dissimilarly to FIG. 1, the armature may be provided as a single layer and may also be formed in a straight line type and a symmetric/asymmetric type.

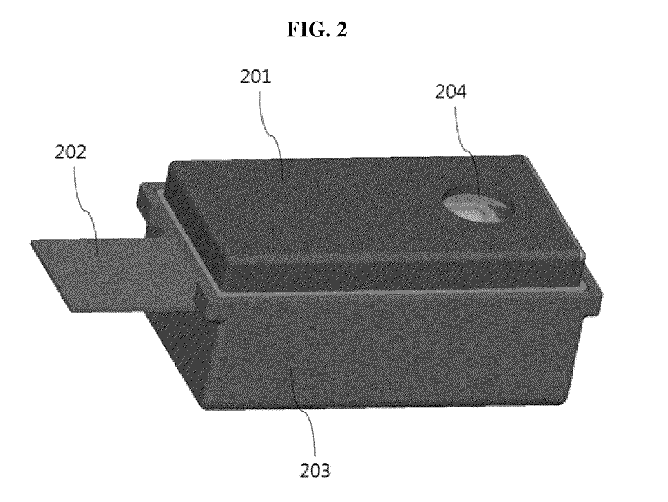

One end of the armature 102 may be connected to one end of the rod 101. In an example, a hole may be formed at the one end of the rod 101 as illustrated in FIG. 2. In another example, the rod 101 may not have a hole at the one end. Also, the rod 101 may have a single hole or a plurality of hole s.

When at least one hole is formed at the one end of the rod 101, the one end of the armature 102 to be connected with the rod 101 may be formed to be insertable in the hole. When manufacturing the balanced armature, the one end of the armature 102 may be assembled to be inserted in the hole of the rod 101 such that the armature 102 and the rod 101 are connected to each other. For example, the one end of the armature 102 may be formed to have a reversed T shape protruding portion and a number of the protruding portions may be the same as the number of holes formed at the one end of the rod 101.

The diaphragm 100 may also include a guide. The guide may be used when housing the balanced armature. In an example of FIG. 1, the guide may be configured to fix the diaphragm 100.

In related arts, the guide may be provided separate from the diaphragm 100 and connected to the diaphragm 100 using an adhesive. In this instance, when an amount of adhesive is controlled inaccurately, the vibration may abnormally occur in the diaphragm 100, which may lead to degradation in a quality of the sound reproduced by the balanced armature. Also, since it is technically difficult to adjust a modulus of elasticity for the vibration of the diaphragm 100 using the adhesive, manufacturing costs may increase.

To this end, in FIG. 1, the guide and the diaphragm 100 may be integrally formed with each other. Through this, when manufacturing the balanced armature, it is possible to produce the diaphragm 100 including the guide and the rod 101 through one time of metal press work without need to separately produce the guide and the rod 101 and connect the guide and the rod 101 with the diaphragm 100 through welding or bonding. Accordingly, it is possible to significantly reduce manufacturing time and manufacturing costs of the diaphragm 100.

Concisely, the rod 101 to be connected with the armature 102 and the guide configured to fix the diaphragm 100 may be integrally formed with the diaphragm 100 and included in the diaphragm 100 as a portion of elements of the diaphragm 100.

Here, the rod 101 configured to deliver the vibration of the armature 102 to the diaphragm 100 may be integrally formed with the diaphragm 100 so as to be included in the diaphragm 100 as an element. The guide configured to fix the diaphragm 100 may also be integrally formed with the diaphragm 100 and included in the diaphragm 100 as an element. The guide may be used in a process of housing the armature 102. In this instance, the guide may be used to fix the diaphragm 100 as described above.

The one end of the armature 102 may be connected to the one end of the rod 101. As an example, a hole may be formed at the one end of the rod 101. As another example, the rod 101 may not have a hole at the one end. Also, the rod 101 may have a single hole or a plurality of holes.

When at least one hole is provided at the one end of the rod 101, the one end of the armature 102 to be connected with the rod 101 may be formed to be insertable in the hole. When manufacturing the armature 102, the one end of the armature 102 may be assembled to be inserted in the hole of the rod 101 such that the armature 102 and the rod 101 are connected to each other. For example, the one end of the armature 102 may be formed to have a reversed T shape protruding portion and a number of the protruding portions may be the same as the number of holes provided at the one end of the rod 101.

The guide may need to fix the diaphragm 100 while allowing the diaphragm 100 to vibrate in connection with the vibration of the armature 102. To allow the diaphragm 100 to vibrate in connection with the vibration of the armature 102, a modulus of elasticity K may need to be maintained based on the vibration while maintaining a connection with the guide. According to an increase in the modulus of elasticity, power for ensuring a vibration corresponding to a predetermined length may also increase.

The modulus of elasticity of the diaphragm 100 may be determined based on a size of an area in which the diaphragm 100 is connected with the guide. The size of the area in which the diaphragm 100 is connected with the guide may vary based on a number of holes. The size of the area may decrease according to an increase in the number of holes. Thus, the modulus of elasticity of the diaphragm 100 may decrease according to the decrease in the size of the area. Similarly, the modulus of elasticity of the diaphragm 100 may vary based on a size of the hole. The modulus of elasticity of the diaphragm 100 may decrease according to an increase in the size of the hole.

Alternatively, the size of the area in which the diaphragm 100 is connected with the guide may vary based on a thickness of a connector or the number of connectors included in the area in lieu of the number of holes.

The size of the area may decrease according to a decrease in the number of connectors. Also, the size of the area may decrease according to a decrease in the thickness of the connector. Thus, the modulus of elasticity of the diaphragm 100 may decrease according to a decrease in a size of an area 203.

Power of the guide fixing the diaphragm 100 may decrease according to the decrease in the size of the area. Thus, a shape of the area may need to be determined based on the modulus of elasticity of the diaphragm 100 and the fixing power of the guide. Thus, the number of holes, the number of connectors, or the thickness of connector included in the area may need to be determined based on the modulus of elasticity of the diaphragm 100 and the fixing power of the guide.

A fixture configured to fix the diaphragm 100 may also be integrally formed with the diaphragm 100 and included in the diaphragm 100 as an element. The fixture may need to be connected with a separate guide.

In this instance, the one end of the rod 101 included in the diaphragm 100 may be in a hole shape or an 11 shape. Thus, the one end of the armature 102 to be connected to the one end of the rod 101 may be formed in a shape corresponding to the shape of the one end of the rod 101.

An area in which the diaphragm 100 is connected with the fixture may also include at least one hole or at least one connector. As the foregoing, the modulus of elasticity of the diaphragm 100 may vary based on a size of the area. The size of the area may decrease according to a decrease in a number of holes. The size of the area may increase according to an increase in a number of connectors. Also, the size of the area may increase according to an increase in a thickness of the connector. When the size of the area increases, power of the fixture fixing the diaphragm 100 may correspondingly increase and thus, the modulus of elasticity of the diaphragm 100 may also increase.

According to an example embodiment, the one end of the rod 101 included in the diaphragm 100 may include a hole or at least one protrusion having a predetermined length. As an example, when the one end has one protrusion, the one protrusion may be provided in a 1 shape. As another example, when the one end has two protrusions, the two protrusions may be provided in an 11 shape.

The balance armature may include the diaphragm 100 and the armature 102. A portion of the armature 102 may be covered by a permanent magnet. Also, another portion of the armature 102 may be covered by a voice coil. The voice coil may have a magnetic polarity such as an S-pole or an N-pole based on a signal to be reproduced. The armature 102 may have an electrode based on the magnetic polarity of the voice coil. Based on the magnetic property of the voice coil and the electrode of the armature 102, the armature 102 may move in a vertical direction and thus, a vibration may occur. Since the armature 102 moves to be balanced between permanent magnets, a device including the armature 102 may be defined as the balanced armature.

An electronic circuit may indicate a flexible printed circuit (FPC) and be connected to the voice coil. Thus, an acoustic signal may be delivered to the voice coil through the electronic circuit.

In this instance, the guide may be integrally formed with the diaphragm 100 to fix the diaphragm 100. The diaphragm 100 may be integrally formed with the fixture that is provided separately from the guide. The fixture may be configured to fix the diaphragm 100 and integrally formed with the diaphragm 100.

The diaphragm 100 may also be integrally formed with the rod 101 configured to deliver the vibration of the armature 102. The diaphragm 100 may also be integrally formed with the connector disposed in the area in which the fixture is connected with the diaphragm 100. Accordingly, the fixture, the connector, and the rod 101 may be included in the diaphragm 100 as elements of the diaphragm 100.

In an example, the diaphragm 100 may be integrally formed with the guide except the fixture and the connector. In another example, the diaphragm 100 may be directly connected to the fixture except the connector so as to be formed in an integrated form. In still another example, the diaphragm 100 may be integrally formed with the connector except the fixture so as to be connected to the guide.

The number of connectors or the thickness of the connector may vary based on the modulus of elasticity of the diaphragm 100 moving in response to the vibration of the armature 102. For example, to increase the modulus of elasticity of the diaphragm 100, the number of connectors may decrease or the thickness of the connector may also decrease.

The one end of the rod 101 may be connected to the one end of the armature 102 to deliver the vibration of the armature 102 to the diaphragm 100. The one end of the rod 101 may be in the 11 shape. The one end of the rod 101 may be in the hole shape and include the at least one hole as the foregoing. Alternatively, the one end of the rod 101 may be in the 1 shape. Accordingly, any shape formed to be connected with the armature 102 is applicable to the one end of the rod 101.

The fixture may be an element configured to fix the diaphragm 100. The fixture may be connected to the guide for housing with an outer case of the balanced armature. In this instance, the fixture may be disposed on a partial area of the guide. For example, the fixture may not be disposed on an upper face of the guide and may be disposed on an area below the upper face by a predetermined depth. Thus, a portion of the upper face of the guide may have a double step difference to be connected with the fixture.

Concisely, in the example embodiments, the diaphragm 100 may be integrally formed with elements as described below. Here, at least one connector may be provided. Also, the rod 101 may include at least one protrusion or at least one hole having a predetermined length to be connected with the armature 102.

(i) Diaphragm 100-Rod 101

(ii) Diaphragm 100-Rod 101 and Connector

(iii) Diaphragm 100-Rod 101 and Fixture

(iv) Diaphragm 100-Rod 101, Connector, and Fixture

(v) Diaphragm 100-Rod 101 and Guide

(vi) Diaphragm 100-Rod 101, Connector, and Guide

(vii) Diaphragm 100-Rod 101, Fixture, and Guide

FIG. 2 is a diagram illustrating a balanced armature according to an example embodiment.

In FIG. 2, a balance armature may be provided in a form in which an outer case and a cover having a sound hole 204 cover the balances armature. Also, an electronic circuit may be provided in a flexible form and protrude to an outside of the balanced armature to deliver an acoustic signal from an external source to a coil of the balanced armature.

### DESCRIPTION OF THE REFERENCE NUMERALS

100: Diaphragm
101: Rod
102: Armature

1. An earphone comprising:
an armature configured to vertically move between permanent magnets based on a magnetic polarity of a coil; and
a diaphragm configured to vertically move in response to a vibration occurring based on a movement of the armature,
wherein the diaphragm is integrally formed with a rod configured to deliver the vibration occurring based on the movement of the armature.

2. The earphone of claim 1, wherein the rod is disposed perpendicular to a partial area of the diaphragm.

3. The earphone of claim 1, wherein one end of the rod is connected to one end of the armature.

4. The earphone of claim 1, wherein at least one hole or at least one protrusion having a predetermined length is provided at one end of the rod.

5. An earphone comprising:
an armature configured to vertically move between permanent magnets based on a magnetic polarity of a coil; and
a diaphragm configured to vertically move in response to a vibration occurring based on a movement of the armature,
wherein the diaphragm is integrally formed with a fixture configured to fix the diaphragm or a rod configured to deliver the vibration occurring based on the movement of the armature.

6. The earphone of claim 5, wherein an area in which the diaphragm and the fixture are connected to each other is present, and a connector for a modulus of elasticity of the diaphragm is disposed in the area.

7. The earphone of claim 6, wherein a length of the connector, a thickness of the connector, or a number of connectors is determined based on the modulus of elasticity of the diaphragm.

8. The earphone of claim 5, wherein an area in which the diaphragm and the fixture are connected to each other is present, and a hole for a modulus of elasticity of the diaphragm is formed in the area.

9. The earphone of claim 8, wherein a size of the hole or a number of holes is determined based on the modulus of elasticity of the diaphragm.

10. The earphone of claim 5, wherein the rod is disposed perpendicular to a partial area of the diaphragm.

11. The earphone of claim 5, wherein one end of the rod is connected to one end of the armature.

12. The earphone of claim 5, wherein at least one hole or at least one protrusion having a predetermined length is provided at one end of the rod.

13. An earphone comprising:
an armature configured to vertically move between permanent magnets based on a magnetic polarity of a coil; and
a diaphragm configured to vertically move in response to a vibration occurring based on a movement of the armature,
wherein the diaphragm is integrally formed with a guide used in housing of the earphone or a rod configured to deliver the vibration occurring based on the movement of the armature.

14. The earphone of claim 13, wherein the guide comprises an area forming a double step difference with an upper face of the guide so as to arrange the diaphragm below the upper face by a predetermined depth.

15. The earphone of claim 13, wherein the rod is disposed perpendicular to a partial area of the diaphragm.

16. The earphone of claim 13, wherein one end of the rod is connected to one end of the armature.

17. The earphone of claim 13, wherein at least one hole or at least one protrusion having a predetermined length is formed at one end of the rod.

18. The earphone of claim 1, wherein the armature is divided into an upper portion and a lower portion having a symmetric relationship or an asymmetric relationship, or the armature is not divided into the upper portion and the lower portion.

19. The earphone of claim 18, wherein when the armature is divided into the upper portion and the lower portion, the armature is provided in a U shape or a 90-degree rotated U shape.

20. An earphone manufacturing method comprising:
arranging an armature;
arranging a diaphragm integrally formed with a rod directly connected to the armature at an upper end of the armature;
arranging a coil covering the armature; and
arranging a permanent magnet in an area different from an area in which the coil is arranged.

21. The earphone manufacturing method of claim 20, further comprising:
arranging a guide used in housing of the earphone,
wherein the guide is integrally formed with the diaphragm, or connected to the diaphragm through a fixture or a connector of the diaphragm.
